(19) United States
(12) Patent Application Publication
(10) Pub. No.: US 2003/0190054 A1
(43) Pub. Date: Oct. 9, 2003

(54) Method and system for distributing digital content with embedded message

(76) Inventors: Lidror Troyansky, Givataim (IL); Oren Tirosh, Hasharon (IL); Ariel Peled, Even-Yehuda (IL); Ofir Carny, Kochav-Yair (IL)

Correspondence Address: Anthony Castorina, G E Ehrlich, Suite 207, 2001 Jefferson Davis Highway, Arlington, VA, 22202, US

(21) Appl. No.: 10/398,193

(22) PCT Filed: Oct. 3, 2001
(86) PCT No.: PCT/IL01/00923

(51) Int. Cl. G06K 9/00

(52) U.S. Cl. 382/100

(57) ABSTRACT

A system and a method for providing uniquely marked copies of data content. The method contain two basic phases: a preprocessing phase, which produces a library of marked segments, and a message embedding phase, which utilizes the stored marked segments in order to efficiently produce a personalized version of the content, by selecting various marked segments and inserting the selected marked segments into the data content.

### FIELD OF THE INVENTION

The present invention relates to the fields digital watermarks and steganograms, and more particularly but not exclusively to the distribution of digital content having digital watermarks or steganograms embedded therein.

### BACKGROUND OF THE INVENTION

Methods for usage rights enforcement of digital media or digital content are known. Some of these enforcement methods require that unique digital watermarks be embedded into each copy of the media at the source prior to its distribution to an authorized party. If usage of the content by an unauthorized party is identified, the identity of the authorized party who originally received the content is readily determined from the unique embedded digital watermark.

Watermarks or steganograms are used to embed substantially imperceptible messages into content. Steganographic techniques insert a digital watermark into digital content, in order to provide protection or, more particularly, identification for the digital content. Digital steganography generally works by replacing parts of the information in digital files (such as image, video, sound, text, HTML, and executable files) with different information, in a substantially imperceptible manner. The hidden information can be plain text, cipher text, or even images. Steganography is also used to form a subliminal channel in order to hide a message in an encrypted file as a supplement to encryption.

Unlike printed watermarks, which are intended to be somewhat visible, digital watermarks are designed to be completely invisible, or, in the case of audio clips, inaudible. Moreover, the actual message representing the steganogram must be inserted into the file in such a way that it cannot be manipulated. The digital watermark must also be robust enough to withstand normal changes to the file, such as reductions from lossy compression algorithms. The following watermarking patents are representative of the prior art, and are hereby incorporated by reference, U.S. Pat. Nos. 5,809,139, 5,915,027, 5,960,081, 6,069,914, 6,131,161, 6,278,792, 6,266,430, and 6,246,775.

Current techniques for embedding watermarks into content, in a manner that does not reduce the quality of the media and is sufficiently robust to survive both malicious and non-malicious attempts to remove the watermark, require the use of massive computational resources such as CPU time and computer memory. This is especially true when digital content containing the watermark requires further processing, such as compression or encryption, prior to distribution. Computational resource requirements increase as the number of concurrently embedded watermarks increases. A distribution system's finite computational resources may severely limit the maximum throughput of the system, when each copy of the content distributed to an authorized party must be embedded with a unique watermark identifying the party. It is foreseeable that a real-time distribution system, such as a video on demand system, may have several hundred simultaneous requests for content. The immense computational requirements of embedding these watermarks simultaneously may result in some portion of the requests being denied.

Some prior art systems attempt to solve this problem by reducing the amount of computational resources needed for the embedding, for example by eliminating the need to perform transformations on the data. Yet those methods still require the actual embedding of the data on each copy in a manner that will not be perceived by the user, which is computationally intensive. There is a need for an efficient alternative to the current methods, which significantly reduces data processing at the time of data distribution.

### SUMMARY OF THE INVENTION

According to a first aspect of the present invention there is thus provided a content marker for providing uniquely marked copies of data content, the marker comprising a content segment taker for taking segments of the content, a marker having a predetermined library of marks, wherein the marker is operable to insert different ones of the marks into different copies of at least one of the segments to form a set of marked segments therefrom, a selector for selecting a marked segment for insertion back into the segment, and an inserter for inserting the selected marked segment into the data content.

In a preferred embodiment, the segment taker and the marker form a content preprocessor.

In a further preferred embodiment, the selector and the inserter form a mark adder.

In a further preferred embodiment, the content marker further comprises a content fraction taker for taking fractions of the content such that each of the fractions contains at least one segment, and for outputting the fragment to the segment taker to ensure the segment is taken from the fragment.

In a further preferred embodiment, the content marker further comprises a content segment remover for removing the segments from the content.

Preferably, each of the segments is salient to the content, such that removal of the segment degrades the content. In a preferred embodiment, the marked content is not degraded relative to the content.

In a further preferred embodiment, each of the marked segments represents a predefined character, and wherein the content marker is operable to embed a message into the content.

In a preferred embodiment, the sets of marked segments are generated prior to distribution of the content.

In a further preferred embodiment, inserting the selected marked segments into the data content is performed during distribution of the content.

In a preferred embodiment, the content comprises one of the following: audio content, multimedia content, or data.

In a further preferred embodiment, the content comprises video content. Preferably, the content segment taker is operable to identify a video object.

In a preferred embodiment, the video object comprises a video frame.

In a further preferred embodiment, the video object comprises a video object plane.

In a further preferred embodiment, the video object comprises a sequence of video frames.

In a preferred embodiment, the marker is operable to insert the mark into the copy of the segment by direct-sequence spread spectrum watermarking.

In a preferred embodiment, the content marker further comprises a message encoder for performing error correction encoding on the message.

In a preferred embodiment, the content marker further comprises a message encrypter for encrypting the message.

According to a second aspect of the present invention there is thus provided a mark detector for detecting a mark embedded in data content, wherein the mark comprises a string of marks composed from a finite library of marks, the mark identifier comprising a maximum-likelihood detector for performing maximum-likelihood detection upon the content thereby to detect marks present in the string.

In a preferred embodiment, the string of marks comprises a message.

In a further preferred embodiment, the message comprises a code identifying an intended receiver of the content.

In a preferred embodiment, the string of marks comprises a single mark.

In a preferred embodiment, the marks comprise symbols of an alphabet.

In a preferred embodiment, the mark detector further comprises a segment identifier for identifying a segment of the content having a portion of the mark embedded therein.

In a preferred embodiment, the mark detector is operable to perform maximum-likelihood detection in order to identify embedded marks only upon sections of the content containing at least one segment identified by the segment identifier.

In a preferred embodiment, the mark detector further comprises a message decoder for decoding a message from the string.

In a further preferred embodiment, the mark detector further comprises a message decrypter for decrypting a message from the string.

According to a third aspect of the present invention there is thus provided mark detector for detecting a mark embedded in data content, in combination with a mark comprising a string of marks composed from a finite library of marks, the mark identifier comprising a detector for detecting marks present in the string.

In a preferred embodiment, the detector comprises a maximum-likelihood detector for performing maximum-likelihood detection upon the content.

In a further preferred embodiment, the string of marks comprises a message.

In a further preferred embodiment, the message comprises a code identifying an intended receiver of the content.

In a preferred embodiment, the string of marks comprises a single mark.

In a further preferred embodiment, the marks comprise symbols of an alphabet.

In a preferred embodiment, the mark detector further comprises a segment identifier for identifying a segment of the content having a portion of the mark embedded therein.

In a preferred embodiment, the detector is operable to perform maximum-likelihood detection in order to identify embedded marks only upon sections of the content containing at least one segment identified by the segment identifier.

In a preferred embodiment, the detector further comprises a message decoder for decoding a message from the string.

In a preferred embodiment, the detector further comprises comprising a message decrypter for decrypting a message from the string.

According to a fourth aspect of the present invention there is thus provided a content preprocessor for providing sets of uniquely marked segments of data content, the preprocessor comprising a content segment taker for taking at least one segment of the content, and a marker having a predetermined library of marks for inserting different ones of the marks into different copies of at least one of the segments to form a set of marked segments therefrom.

In a preferred embodiment, the content preprocessor further comprises a content fraction taker for taking fractions of the content such that each of the fractions contains at least one segment, and for outputting the fragment to the segment taker to ensure the segment is taken from the fragment.

In a further preferred embodiment, the content preprocessor further comprises a content segment remover for removing the segments from the content.

In a preferred embodiment, each of the segments is salient to the content, such that removal of the segment degrades the content.

In a further preferred embodiment, each of the marked segments represents a predefined character.

In a preferred embodiment, wherein the content comprises one of the following: audio content, multimedia content, or data.

In a further preferred embodiment, the content comprises video content.

In a preferred embodiment, the content segment taker is operable to identify a video object.

In a further preferred embodiment, the video object comprises a video frame.

In a further preferred embodiment, the video object comprises a video object plane.

In a further preferred embodiment, the video object comprises a sequence of video frames.

According to a fifth aspect of the present invention there is thus provided a mark adder for inserting marked segments into predefined locations within data content, thereby to provide uniquely marked copies of the data content, the adder comprising a library of marked segments containing a set of marked segments for each of the locations, a selector for selecting at least one location within the content, and an inserter for inserting into at least one of the selected locations a marked segment from the set of marked segments of the location.

In a preferred embodiment, the adder further comprises a content portion remover for removing a portion of data content from at least one location within the content.

In a preferred embodiment, each of the portions of data content is salient to the content, such that removal of the portion degrades the content.

In a further preferred embodiment, the marked content is not degraded relative to the content.

In a preferred embodiment, each of the marked segments represents a predefined character, and wherein the adder is operable to embed a message into the content.

In a preferred embodiment, the content comprises one of the following: audio content, multimedia content, or data.

In a further preferred embodiment, the content comprises video content.

In a preferred embodiment, the mark adder further comprises a message encoder for performing error correction encoding on the message.

In a preferred embodiment, the mark adder further comprises a message encrypter for encrypting the message.

According to a sixth aspect of the present invention there is thus provided a method for providing uniquely marked copies of data content, comprising the steps of: taking segments of the content, for each of the content segments, inserting different ones of marks taken from a predetermined library of marks into the segment to form a set of marked segments therefrom, and marking the data content by performing for at least one of the content segments the steps of: selecting a marked segment from the set of marked segments of the segment, and inserting the selected marked segment into a predefined location in the data content.

In a preferred embodiment the method comprises the further step of storing the sets of marked segments.

In a preferred embodiment the method comprises the further step of the further step of removing at least one of the content segments from the data content.

In a preferred embodiment, each of the content segments is salient to the content, such that removal of the segment degrades the content.

In a further preferred embodiment, forming the sets of marked segments is performed prior to distribution of the content.

In a preferred embodiment, marking the content is performed during distribution of the content.

In a preferred embodiment the method comprises the further step of taking at least one fraction of the content, such that the fraction contains at least one of the content segments thereby to ensure that at least one of the content segments is taken from the fragment.

In a preferred embodiment, the marked copies of data content are not degraded relative to the data content.

In a preferred embodiment, each of the marked segments represents a predefined character.

In a preferred embodiment, a marked copy of data content contains a message embedded therein.

In a preferred embodiment, the method comprises the further step of performing error correction encoding on the message.

In a further preferred embodiment, the method comprises the further step of encrypting the message.

In a preferred embodiment, the content comprises one of the following: audio content, video content, multimedia content, or data.

In a preferred embodiment, a segment comprises a video frame, and wherein the data content is marked with a message comprising a sequence of marks by performing the steps of: encoding the message into an encoded message using an error-correction code, transforming the encoded message into a message matrix, generating a pseudo-noise sequence and transforming the sequence into a pseudo-noise matrix, combining the pseudo-noise matrix and the message matrix into a control matrix using the tensor product of the two matrices, obtaining the video frame in a YUV format, dividing the Y component into blocks, extracting from each block the value of a component for manipulation during the embedding process, manipulating the value of the components in accordance with the numbers in the control matrix to form a steganogram template, combining the template with the original frame, storing the frame and a sequence previously watermarked frames in a file, and encoding the sequence of frame into a digital video format.

According to a seventh aspect of the present invention there is thus provided a method for providing sets of uniquely marked segments of data content, comprising the steps of: taking segments of the content, for each of the content segments, inserting different ones of marks taken from a predetermined library of marks into the segment to form a set of marked segments therefrom.

In a preferred embodiment, each of the content segments is salient to the content, such that removal of the segment from the content degrades the content.

In a preferred embodiment the method comprises the further step of taking at least one fraction of the content, such that the fraction contains at least one of the content segments thereby to ensure that at least one of the content segments is taken from the fragment.

In a further preferred embodiment, each of the marked segments represents a predefined character.

In a further preferred embodiment, the content comprises one of the following: audio content, video content, multimedia content, or data.

According to an eighth aspect of the present invention there is thus provided a method for providing uniquely marked copies of data content by inserting one of a selection of segments into a set of predefined locations within the data content, comprising: providing, for each predefined location, a set of differently marked copies of a respective segment for the location, selecting a marked copy from the set of marked segments of the respective location, and inserting the selected marked segment into the respective location in the data content.

In a preferred embodiment the method comprises the further step of the further step of removing from at least one of the locations a segment of the data content.

In a preferred embodiment, each of the content segments is salient to the content, such that removal of the segment degrades the content.

In a preferred embodiment, marking the content is performed during distribution of the content.

In a preferred embodiment the method comprises the further step of taking at least one fraction of the content, such that the fraction contains at least one of the content segments thereby to ensure that at least one of the content segments is taken from the fragment.

In a preferred embodiment, the marked copies of data content are not degraded relative to the content.

In a further preferred embodiment, each of the marked segments represents a predefined character.

In a preferred embodiment, a marked copy of data content contains a message embedded therein.

In a preferred embodiment the method comprises the further step of performing error correction encoding on the message.

In a further preferred embodiment the method comprises the further step of comprising encrypting the message.

In a further preferred embodiment, the content comprises one of the following: audio content, video content, multimedia content, or data.

In a further preferred embodiment, a segment comprises a video frame, and wherein the data content is marked with a message comprising a sequence of marks by performing the steps of: encoding the message into an encoded message using an error-correction code, transforming the encoded message into a message matrix, generating a pseudo-noise sequence and transforming the sequence into a pseudo-noise matrix, combining the pseudo-noise matrix and the message matrix into a control matrix using the tensor product of the two matrices, obtaining the video frame in a YUV format, dividing the Y component into blocks, extracting from each block the value of a component for manipulation during the embedding process, manipulating the value of the components in accordance with the numbers in the control matrix to form a steganogram template, combining the template with the original frame, storing the frame and a sequence previously watermarked frames in a file, and encoding the sequence of frame into a digital video format.

According to a ninth aspect of the present invention there is thus provided a method for watermarking data content by inserting one of a selection of previously removed segments into a set of predefined locations within the data content, comprising: obtaining, for each predefined location, a set of differently marked copies of a respective segment for the location, selecting a marked copy from the set of marked segments for each respective location, and inserting the selected marked segment into the respective location in the data content.

In a preferred embodiment, the marked copies of data content are not degraded relative to the content.

In a further preferred embodiment, each of the marked segments represents a predefined character.

In a preferred embodiment, a marked copy of data content contains a message embedded therein.

### BRIEF DESCRIPTION OF THE DRAWINGS

For a better understanding of the invention and to show how the same may be carried into effect, reference will now be made, purely by way of example, to the accompanying drawings, in which:

FIG. 1 is a simplified block diagram of a preferred embodiment of a content marker.

FIG. 2 is a schematic diagram illustrating the creating of a marked segment set from data content.

FIG. 3 is a simplified block diagram of a further preferred embodiment of a content marker.

FIG. 4 is a data store comprising sets of marked segments.

FIG. 5 is a simplified block diagram of a preferred embodiment of a mark detector.

FIG. 6 is a simplified flow chart of a method for providing uniquely marked copies of data content.

FIG. 7 is a simplified flow chart of an embodiment of a method for generating sets of marked segments for embedding a mark into digital content.

FIG. 8 is a simplified flow chart of a further embodiment of a method for embedding marked segments into digital content.

FIG. 9 is a simplified flowchart of a method of watermark detection.

FIG. 10 is a simplified flowchart of a method of direct-sequence spread spectrum watermarking.

### DESCRIPTION OF THE PREFERRED EMBODIMENTS

Digital watermarking technology provides distributors of data content with the ability to insert or embed digital watermarks into data, video, audio, or other multimedia content. One function of digital watermarks is to insert a personalized message into each copy of the data content, in a robust manner, without degrading the content. The content distributor is then able to monitor unauthorized usage of the data by receiving parties. The preferred embodiments described below may be used as part of an on-line, real-time content distribution system, such as a video or audio on demand system operating over the Internet or some other network.

In the description below, reference is made to marked segments of the data content. A marked segment comprises a segment of data content, which contains a unique, preferably substantially imperceptible mark. Each marked segment comprises a version of the unmarked segment. Versioning of segments can be performed utilizing standard-watermarking techniques, but can also be performed by changing some of the information in content, e.g., by performing small geometric transformations in video frames.

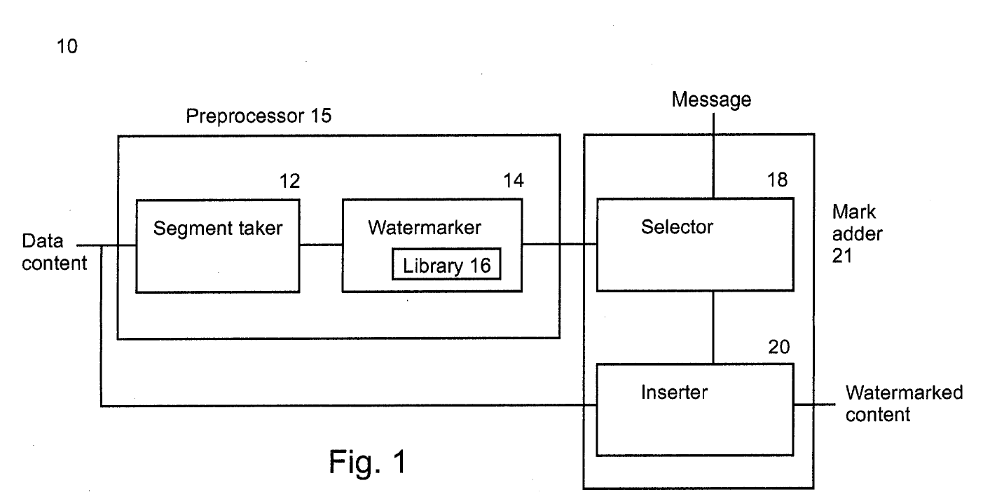

Reference is now made to FIG. 1, which is a simplified block diagram of a preferred embodiment of a content marker 10. The content marker provides uniquely marked copies of data content. The content marker comprises a content segment taker 12, a marker 14 having a predetermined library of marks 16, a selector 18, and an inserter 20. The content segment taker 12 selects segments of the data content for further processing. In the preferred embodiment each of the segments is salient to the data content, so that removal of the segment from the content causes a degradation of the content. In a further preferred embodiment the segments are part of larger sections of the content, denoted fractions. The content marker then contains a fraction taker preceding the segment taker 12, which selects the data fragments prior to selection of the segments from the fractions.

After selection of the data segments, the marker 14 processes the segments. The marker 14 inserts marks into copies of the segments, thereby forming a set of marked segments from each segment taken from the data content. The marks used are stored in library 16, and may be inserted into the segments by any known marking technique. The marked segments comprise versioned segments of the digital content, such that each set preferably contains more than one version of the segment, and each version contains a unique watermark. In a preferred embodiment, the sets that are formed by the preprocessor are thereafter stored in a data store, from which they are accessed during the marking and distribution of the data content.

In a preferred embodiment, the marking is performed by inserting digital watermarks into segments of the content by any known digital watermarking method, for example by direct-sequence spread spectrum, as described below. In another preferred embodiment, the mark is inserted into the segment by generating versions of the content having substantially imperceptible differences between them.

In a preferred embodiment the content segment taker 12 and marker 14 form a content preprocessor 15. The content preprocessor forms the sets of marked segments prior to distribution of the data content.

In a preferred embodiment content marker 10 further comprises a segment remover, which removes the data segments from the data content.

After generation of the sets of marked segments, the content is prepared for distribution. Selector 18 selects a marked segment for insertion back in place of one or more segments. Inserter 20 then inserts each selected marked segment in place of the unmarked segment it was generated from. The data content is thus modified to incorporate a preferably unique sequence of marks. In the preferred embodiment, the marked content is not degraded relative to the original data content. In a preferred embodiment selector 18 and inserter 20 form a mark adder, that receives sets of marked segments and inserts the desired sequence of marks into data content during content distribution.

In a preferred embodiment each of the marked segments represents a predefined character, and the sequence of marks in the content forms a message. This message may be received by the content marker 10 from an external source, and may vary for each copy of the content distributed. In further embodiments, the content marker 10 comprises an encoder for performing error correction encoding on the message, and/or an encrypter for encrypting the message prior to insertion into the content.

The data content comprises any form of data, including audio, video, or multimedia. In a preferred embodiment where the data content comprises video data, the segment taker 12 identifies a video object, such as a video frame, sequence of video frames, or video object plane (VOP), and utilizes the video object, or a portion thereof, as a segment.

In a preferred embodiment, selecting fractions and/or segments of the data content is done not only in the time domain but also, or alternatively, in other domain or domains, such as frequency bands, or parts of frames.

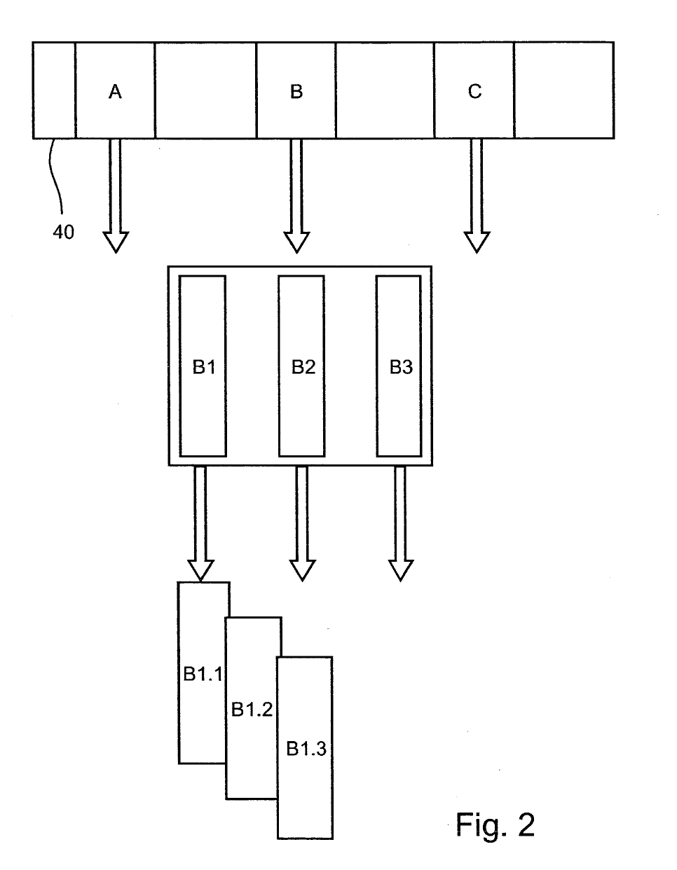

Reference is now made to FIG. 2, which is a schematic diagram illustrating the creating of a marked segment set from data content 40. The top of the illustration shows a data stream 40, which is partitioned into three fractions A, B, and C. The middle portion of the illustration shows fraction B partitioned into segments B1, B2, and B3. The bottom the figure shows three marked copies of segment B1. Marking separate copies of segment B1 with a different and distinct mark has created a set of marked segments B1.1, B1.2, and B1.3.

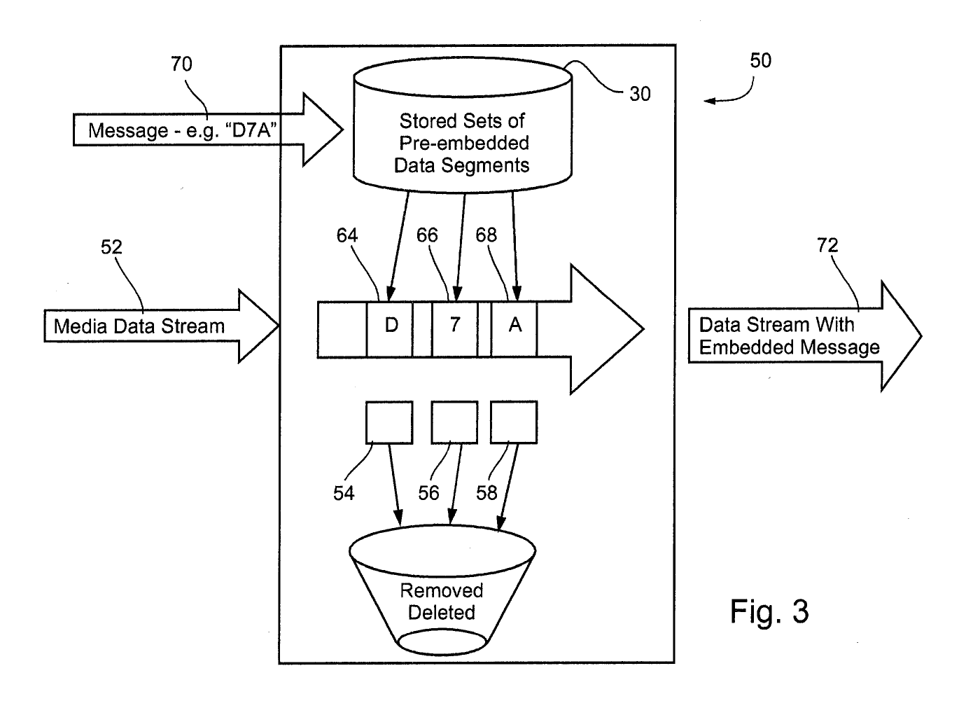

Reference is now made to FIG. 3, which is a simplified block diagram of a further preferred embodiment of a content marker 50. Data stream 52, representing some media or data content, enters the content marker 50. In a preferred embodiment, predetermined unmarked segments 54, 46, and 58 of the stream 52 are removed from the data content prior to data content processing by content marker 50. Content marker 50 replaces the removed segments by marked segments 64, 66, and 68 respectively. Each of the marked segments is marked with a symbol correlating to a symbol in message 70. The resulting output data stream 72 incorporates data segments 64, 66, and 68 which have the message symbols “D”, “7”, and “A” embedded therein. Output data stream 72 thus carries message 70 within it.

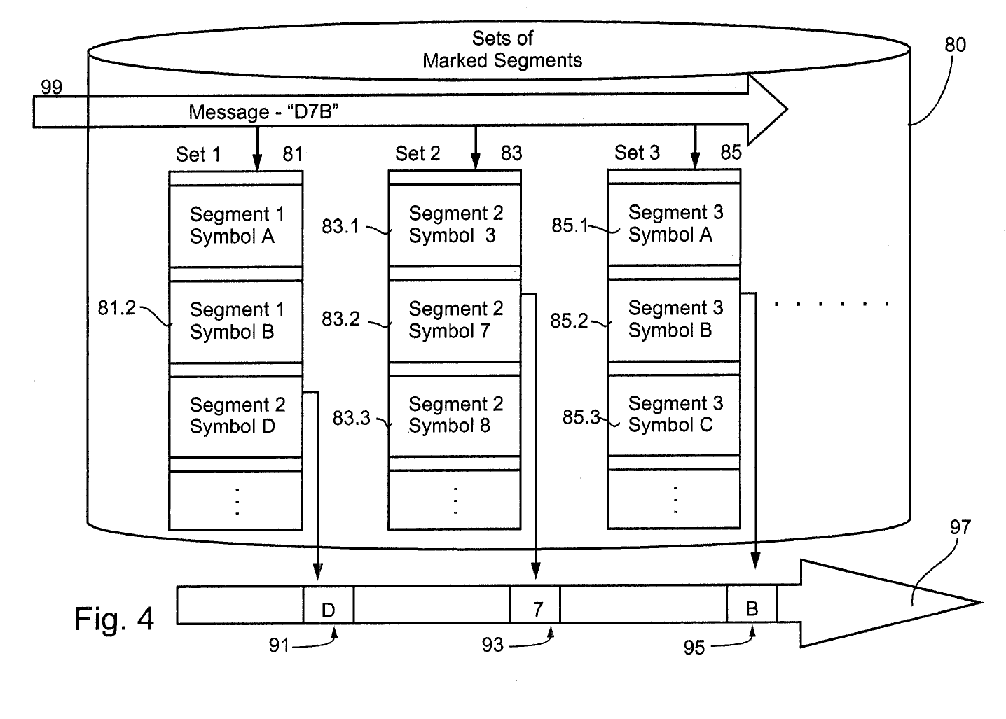

Reference is now made to FIG. 4, which shows data store 80 comprising sets of marked segments 81, 83 and 85, where each set contains marked segments interchangeable with data segments 91, 93 and 95 respectively in data stream 97. For example, all the marked segments in Set 1 81 represent segment 91 of the data stream. Replacing data segment 91 with any of the data segments in Set 1 81 preferably causes an imperceptible change in the content represented by the data stream 97. The imperceptible change is due to the unique mark embedded in each of the replacement data segments.

In the preferred embodiment, the symbols embedded in each of the marked segments within a given set collectively form a set of logical symbols or characters. Any of the characters may be inserted into the data stream 97 in the position of the data segment associated with the given set. For example, the message 99 “D7B” is embedded into data stream 97 by replacing data segment 94 with replacement data segment 81.3, replacing data segment 93 with replacement data segment 83.2, and replacing data segment 95 with replacement data segment 85.2. Choosing a different replacement marked segment from any of the sets would result in a different character being marked in the position of the set associated data segment within the data stream 97.

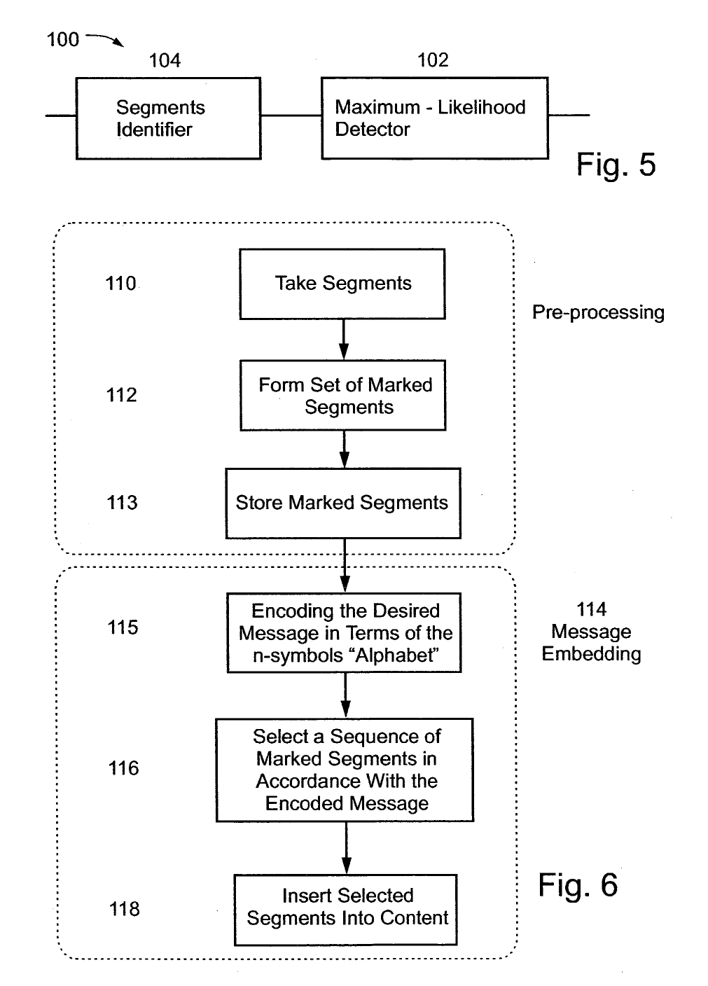

Reference is now made to FIG. 5, which is a simplified block diagram of a preferred embodiment of a mark detector 100. Mark detector 100 comprises maximum-likelihood detector 102, which detects a mark embedded in digital content by performing maximum-likelihood detection upon the content to detect the string of marks. In the preferred embodiment, the set of possible marks is relatively small. Thus the maximum likelihood detector 102 can perform an exhaustive search over all the possible versions, and thereby assert the likelihood of each version regardless of the watermark embedding technique or any other versioning scheme. In the preferred embodiment, the string of marks comprises a message, which identifies an intended receiver of the digital content. In a preferred embodiment, mark detector 100 further comprises a segment identifier 104, which isolates segments of the data containing marks, and the maximum-likelihood detection is performed only upon these sections, thereby increasing the efficiency of the detection process. Other embodiments of the detector comprise a message decoder to decode the embedded message, and/or a message decrypter to decrypt the message.

Reference is now made to FIG. 6, which is a simplified flow chart of a method for providing uniquely marked copies of data content. The method contains two basic phase: a preprocessing phase which produces a data store of marked segments (steps 110-113), and a message embedding phase (stages 114-118). The message embedding phase utilizes the stored marked segments in order to efficiently produce a personalized version of the content.

In step 110, segments of the content are selected. In stage 112, different versions of the segments are produced by changing properties of the segments in a manner that preferably does not reduce the quality of the content, and preferably are substantially imperceptible, thereby forming a set of marked segments for each content segment. These segments are stored in a data store in step 113.

During the message embedding phase desired message is encoded in terms of an “n-symbol alphabet” in step 115. In step 116 a sequence of marked copies is selected in accordance with the encoded message. In step 118, the sequence of the selected marked copies is inserted back to the content (e.g., by file concatenation), thereby forming a personalized content with an embedded message.

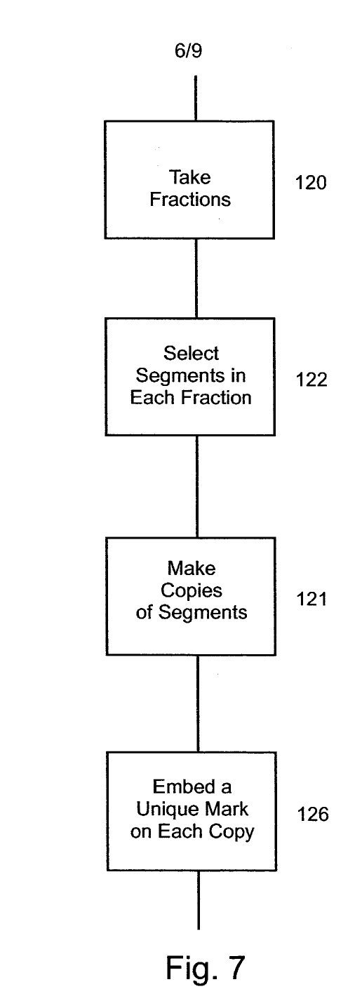

Reference is now made to FIG. 7, which is a simplified flow chart of an embodiment of a method for generating sets of marked segments for embedding a mark into digital content. In step 110, one or more fractions are taken from the data or media content to be marked at some time in the future. In the preferred embodiment, the fraction is selected to be a salient fraction such that its removal from the content would cause a noticeable change or distortion in the content. In a further preferred embodiment where the data stream being marked is multimedia content, the salient fraction is selected such that it represents at least a portion of one object in the multimedia content whose removal reduces the quality of the content. For example, in the case of video media these segments can be frames, video object planes (VOP), or groups of frames.

Next, one or more data segments are selected from each fraction in step 112. The data segments may be of varying lengths. The number of data segments is related to the number of marks to be embedded within the selected fraction. There should be at least as many segments as marks to be embedded. If the number of marks to be embedded is not known in advance, the fraction is partitioned into a number of segments sufficiently high for all contingencies.

In step 114, each segment is replicated into copies, where the number of copies is at least as large as the number of marks that are to be inserted into each segment. In a preferred embodiment the marks represent logical symbols such as characters, which can be selected in order to create a message. Thus, if the possible set of marks to be embedded is [A, B, C, D and E], at least five copies of the data segment are made. In step 116, each copy of the data segment is embedded with one of the symbols. Watermark embedding in digital media is well known, and any one of the known and not yet known methods may be used as part of the present invention, e.g., the methods described in U.S. Pat. Nos. 5,809,139, 5,915,027, 5,960,081, 6,069,914, 6,131,161, 6,278,792, 6,266,430 and 6,246,775. The steps associated with compiling the sets of marked segments are usually performed off-line, where off-line means prior to beginning the distribution of the content over a network.

Each mark or symbol in a set of marked segments for a given segment is unique from each other symbol in the set. Sets of marked data segments associated with different segments of the salient fraction may, but are not required to, contain segments with the same symbols. That is, each set contains an alphabet of logical symbols that may or may not be the same alphabet as symbols contained within other sets associated with other segments. For example, a set associated with a first data segment may contain logical symbols “A”,“B” and “C,” while a set associated with a second segment may contain symbols “C”, “1” and “3”.

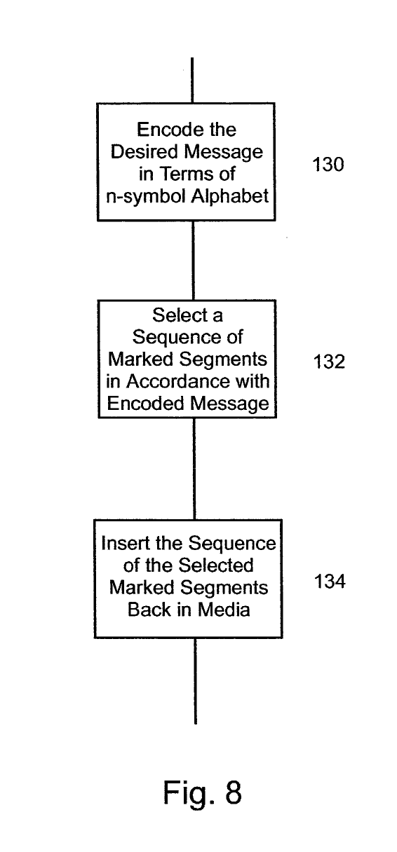

Reference is now made to FIG. 8, which is a simplified flow chart of a further embodiment of a method for embedding marked segments into digital content. This embodiment is suitable for the case where the marks embedded in the marked segments represent logical symbols such as characters. In step 120, a message is encoded in terms of the logical symbols in the marked segments. The set of characters may be considered an alphabet. In step 122, a sequence of marked segments in accordance with the message to be embedded in the content is selected.

Finally, in step 124, each data segment is replaced within the data content by the marked segment having the requisite symbol. For example, within a multimedia data stream for an authorized user whose unique identifying message is “BDR3,” the first data segment within the salient fraction may be replaced with a replicate segment having the symbol “B,” the second segment may be replaced with a replicate segment having the symbol “D,” the third segment may be replaced with a replicate segment having the symbol “R,” and the fourth may be replaced with a replicate segment having the symbol “3.” The marked segments replacing each of the data segments in the salient fraction are selected from the set associated with the replaced segment. In a preferred embodiment the data content is to be distributed over a network and the message selection and insertion into the data content are done during distribution enabling efficient distribution of the data content.

In a preferred embodiment, one or more data segments may be left unmarked. In addition, as the size of the alphabet can be small, the actual information content in the embedded messages can be small, and therefore the embedded message can contain more redundancy, elevating the robustness of the watermark. In further preferred embodiments, the message is encrypted or coded prior to embedding in the data content.

In a preferred embodiment of the present invention, the sequence of marks is spread over more then one fraction of the data content.

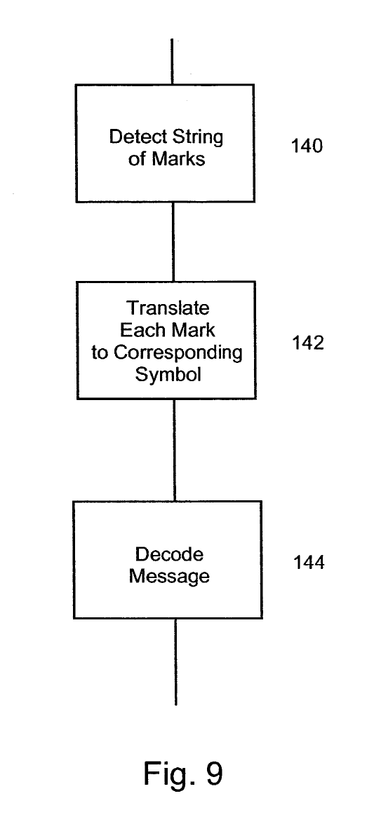

Reference is now made to FIG. 9, which is a simplified flowchart of a method of watermark detection. This method is suitable for the case where the marks embedded in the marked segments represent logical symbols such as characters. In step 130, the string of marks embedded in the data content is detected. In the preferred embodiment, the string of marks is detected by maximum-likelihood detection. In the preferred embodiment, the set of possible marks is relatively small. Thus the maximum likelihood detector 102 can perform an exhaustive search over all the possible versions, and thereby assert the likelihood of each version regardless of the watermark embedding technique or any other versioning scheme. In step 132, each mark is translated to the corresponding logical symbol. In step 134, the original message embedded in the content is decoded.

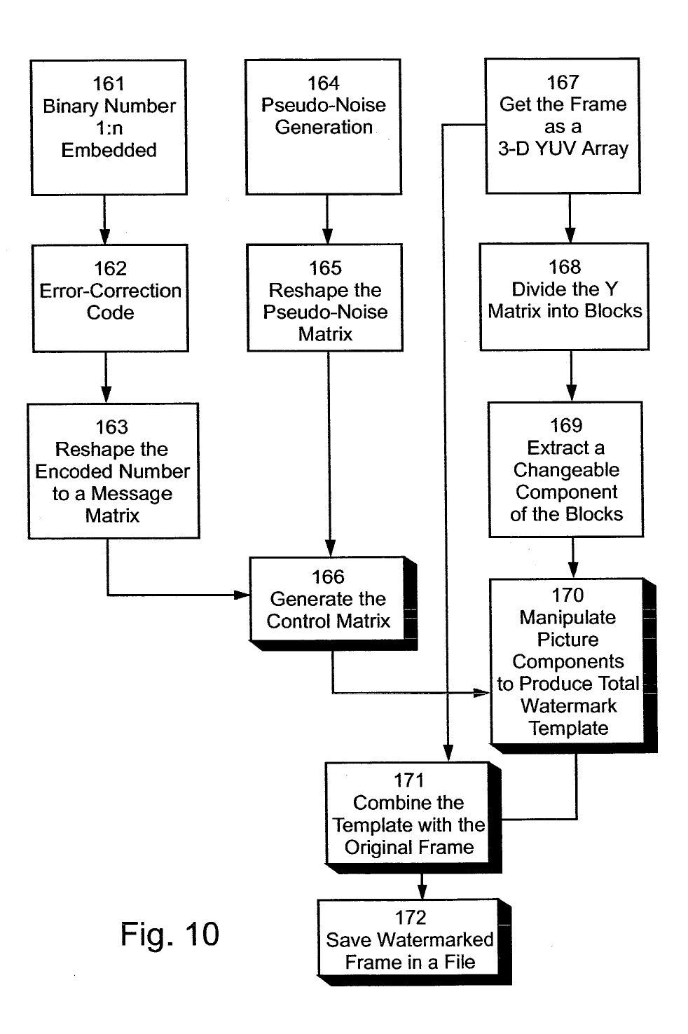

Reference is now made to FIG. 10, which is a simplified flowchart of a method of direct-sequence spread spectrum watermarking that is commonly used in many watermarking schemes, and which may be used as part of the present invention. In step 161, a binary number is selected for encoding. In step 162, the number is encoded using an error-correcting code, such as BCH, Reed-Solomon or turbo code. In step 163, the encoded message is transformed into a matrix for further processing. In step 164 a pseudo-random sequence that will serve as pseudo noise is generated and transformed into a matrix. The pseudo-noise sequence length may preferably be several times the length of the encoded message. The pseudo-noise matrix is reshaped in step 165. The message matrix and pseudo-noise matrix are then combined to form a control matrix in step 166. In the preferred embodiment, the matrices are combined by forming the tensor product (Kronecker product) of the matrices. In step 167 the frame on which the message is embedded is represented as a standard 3D array in YUV format. The Y component on which the steganogram or watermark is to be embedded in the embodiment is divided into blocks in step 168. The value of the component to be manipulated in each block is extracted in step 169. The component can be the DC component of the discrete Fourier transform of the block's elements. In step 170, the components that were extracted in step 169 are manipulated in accordance with the numbers in the control matrix to produce a watermark template. In step 171 the watermark template is combined with the original frame, thereby completing the desired embedding process. The watermarked frame is stored in a file in step 172. In a preferred embodiment, the file may contain a sequence of previously watermarked frames. The entire sequence of frames may subsequently be encoded into a standard digital video format such as MPEG 4, thereby producing the desired building blocks for marking content.

Unauthorized distribution of digital content such as music, video, digital books, and software forms a serious problem for content distributors. Marked versions of the distributed content enable future forensic analysis of versions of the content to determine unauthorized use. Personalized versions of marked digital content provide a content distributor with the ability to monitor content distribution and use.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

We claim:

1. A content marker for providing uniquely marked copies of data content, said marker comprising a content segment taker for taking segments of said content, a marker having a predetermined library of marks, wherein said marker is operable to insert different ones of said marks into different copies of at least one of said segments to form a set of marked segments therefrom, a selector for selecting a marked segment for insertion back into said segment, and an inserter for inserting said selected marked segment into said data content.

2. A content marker according to claim 1, wherein said segment taker and said marker form a content preprocessor.

3. A content marker according to claim 1, wherein said selector and said inserter form a mark adder, for on-line addition of marks to said content.

4. A content marker according to claim 1, wherein said content marker further comprises a content fraction taker for taking fractions of said content such that each of said fractions contains at least one segment, and for outputting said fragment to said segment taker to ensure said segment is taken from said fragment.

5. A content marker according to claim I, wherein said content marker further comprises a content segment remover for removing said segments from said content.

6. A content marker according to claim 1, wherein each of said segments is salient to said content, such that removal of said segment degrades said content.

7. A content marker according to claim 1, wherein said marked content is not degraded relative to said content.

8. A content marker according to claim 1, wherein each of said marked segments represents a predefined character, and wherein said content marker is operable to embed a message into said content.

9. A content marker according to claim 1, wherein said sets of marked segments are generated prior to distribution of said content.

10. A content marker according to claim 1, wherein inserting said selected marked segments into said data content is performed during distribution of said content.

11. A content marker according to claim 1, wherein said content comprises one of the following: audio content, multimedia content, or data.

12. A content marker according to claim 1, wherein said content comprises video content.

13. A content marker according to claim 12, wherein said content segment taker is operable to identify a video object.

14. A content marker according to claim 13, wherein said video object comprises a video frame.

15. A content marker according to claim 13, wherein said video object comprises a video object plane.

16. A content marker according to claim 13, wherein said video object comprises a sequence of video frames.

17. A content marker according to claim 14, wherein said marker is operable to insert said mark into said copy of said segment by direct-sequence spread spectrum watermarking.

18. A content marker according to claim 8, further comprising a message encoder for performing error correction encoding on said message.

19. A content marker according to claim 8, further comprising a message encrypter for encrypting said message.

20. A mark detector for detecting a mark embedded in data content, wherein said mark comprises a string of marks composed from a finite library of marks, said mark identifier comprising a maximum-likelihood detector for performing maximum-likelihood detection upon said content thereby to detect marks present in said string.

21. A mark detector according to claim 20, wherein said string of marks comprises a message.

22. A mark detector according to claim 21, wherein said message comprises a code identifying an intended receiver of said content.

23. A mark detector according to claim 20, wherein said string of marks comprises a single mark.

24. A mark detector according to claim 20, wherein said marks comprise symbols of an alphabet.

25. A mark detector according to claim 20, further comprising a segment identifier for identifying a segment of said content having a portion of said mark embedded therein.

26. A mark detector according to claim 25, wherein said detector is operable to perform maximum-likelihood detection in order to identify embedded marks only upon sections of said content containing at least one segment identified by said segment identifier.

27. A mark detector according to claim 20, further comprising a message decoder for decoding a message from said string.

28. A mark detector according to claim 20, further comprising a message decrypter for decrypting a message from said string.

29. A mark detector for detecting a mark embedded in data content, in combination with a mark comprising a string of marks composed from a finite library of marks, said mark identifier comprising a detector for detecting marks present in said string.

30. A mark detector according to claim 29, wherein said detector comprises a maximum-likelihood detector for performing maximum-likelihood detection upon said content.

31. A mark detector according to claim 29, wherein said string of marks comprises a message.

32. A mark detector according to claim 31, wherein said message comprises a code identifying an intended receiver of said content.

33. A mark detector according to claim 29, wherein said string of marks comprises a single mark.

34. A mark detector according to claim 29, wherein said marks comprise symbols of an alphabet.

35. A mark detector according to claim 29, further comprising a segment identifier for identifying a segment of said content having a portion of said mark embedded therein.

36. A mark detector according to claim 35, wherein said detector is operable to perform maximum-likelihood detection in order to identify embedded marks only upon sections of said content containing at least one segment identified by said segment identifier.

37. A mark detector according to claim 29, further comprising a message decoder for decoding a message from said string.

38. A mark detector according to claim 29, further comprising a message decrypter for decrypting a message from said string.

39. A content preprocessor for providing sets of uniquely marked segments of data content, said preprocessor comprising a content segment taker for taking at least one segment of said content, and a marker having a predetermined library of marks for inserting different ones of said marks into different copies of at least one of said segments to form a set of marked segments therefrom.

40. A content preprocessor according to claim 39, wherein said content preprocessor further comprises a content fraction taker for taking fractions of said content such that each of said fractions contains at least one segment, and for outputting said fragment to said segment taker to ensure said segment is taken from said fragment.

41. A content preprocessor according to claim 39, wherein said content preprocessor further comprises a content segment remover for removing said segments from said content.

42. A content preprocessor according to claim 39, wherein each of said segments is salient to said content, such that removal of said segment degrades said content.

43. A content preprocessor according to claim 39, wherein each of said marked segments represents a predefined character.

44. A content preprocessor according to claim 39, wherein said content comprises one of the following: audio content, multimedia content, or data.

45. A content preprocessor according to claim 39, wherein said content comprises video content.

46. A content preprocessor according to claim 45, wherein said content segment taker is operable to identify a video object.

47. A content preprocessor according to claim 46, wherein said video object comprises a video frame.

48. A content preprocessor according to claim 46, wherein said video object comprises a video object plane.

49. A content preprocessor according to claim 46, wherein said video object comprises a sequence of video frames.

50. A mark adder for inserting marked segments into predefined locations within data content, thereby to provide uniquely marked copies of said data content, said adder comprising a library of marked segments containing a set of marked segments for each of said locations, a selector for selecting at least one location within said content, and an inserter for inserting into at least one of said selected locations a marked segment from said set of marked segments of said location.

51. A mark adder according to claim 50, wherein said adder further comprises a content portion remover for removing a portion of data content from at least one location within said content.

52. A mark adder according to claim 51, wherein each of said portions of data content is salient to said content, such that removal of said portion degrades said content.

53. A mark adder according to claim 51, wherein said marked content is not degraded relative to said content.

54. A mark adder according to claim 50, wherein each of said marked segments represents a predefined character, and wherein said adder is operable to embed a message into said content.

55. A mark adder according to claim 50, wherein said content comprises one of the following: audio content, multimedia content, or data.

56. A mark adder according to claim 50, wherein said content comprises video content.

57. A mark adder according to claim 54, further comprising a message encoder for performing error correction encoding on said message.

58. A mark adder according to claim 54, further comprising a message encrypter for encrypting said message.

59. A method for providing uniquely marked copies of data content, comprising the steps of:
taking segments of said content;
for each of said content segments, inserting different ones of marks taken from a predetermined library of marks into said segment to form a set of marked segments therefrom; and,
marking said data content by performing for at least one of said content segments the steps of:
selecting a marked segment from the set of marked segments of said segment; and,
inserting said selected marked segment into a predefined location in said data content.

60. A method for providing uniquely marked copies of data content according to claim 59, comprising the further step of storing said sets of marked segments.

61. A method for providing uniquely marked copies of data content according to claim 59, comprising the further step of removing at least one of said content segments from said data content.

62. A method for providing uniquely marked copies of data content according to claim 59, such that each of said content segments is salient to said content, such that removal of said segment degrades said content.

63. A method for providing uniquely marked copies of data content according to claim 59, wherein forming said sets of marked segments is performed prior to distribution of said content.

64. A method for providing uniquely marked copies of data content according to claim 59, wherein marking said content is performed during distribution of said content.

65. A method for providing uniquely marked copies of data content according to claim 59, further comprising taking at least one fraction of said content, such that said fraction contains at least one of said content segments thereby to ensure that at least one of said content segments is taken from said fragment.

66. A method for providing uniquely marked copies of data content according to claim 59, wherein said marked copies of data content are not degraded relative to said data content.

67. A method for providing uniquely marked copies of data content according to claim 59, wherein each of said marked segments represents a predefined character.

68. A method for providing uniquely marked copies of data content according to claim 67, wherein a marked copy of data content contains a message embedded therein.

69. A method for providing uniquely marked copies of data content according to claim 68, further comprising performing error correction encoding on said message.

70. A method for providing uniquely marked copies of data content according to claim 68, further comprising encrypting said message.

71. A method for providing uniquely marked copies of data content according to claim 59, wherein said content comprises one of the following: audio content, video content, multimedia content, or data.

72. A method for providing uniquely marked copies of data content according to claim 59, wherein a segment comprises a video frame, and wherein said data content is marked with a message comprising a sequence of marks by performing the steps of:
encoding said message into an encoded message using an error-correction code;
transforming the encoded message into a message matrix;
generating a pseudo-noise sequence and transforming said sequence into a pseudo-noise matrix;
combining the pseudo-noise matrix and the message matrix into a control matrix using the tensor product of the two matrices;
obtaining the video frame in a YUV format;
dividing the Y component into blocks;
extracting from each block the value of a component for manipulation during the embedding process;
manipulating the value of said components in accordance with the numbers in the control matrix to form a steganogram template;
combining said template with the original frame;
storing said frame and a sequence previously watermarked frames in a file; and
encoding said sequence of frame into a digital video format.

73. A method for providing sets of uniquely marked segments of data content, comprising the steps of:
taking segments of said content; for each of said content segments, inserting different ones of marks taken from a predetermined library of marks into said segment to form a set of marked segments therefrom.

74. A method for providing sets of uniquely marked segments of data content according to claim 73, such that each of said content segments is salient to said content, such that removal of said segment from said content degrades said content.

75. A method for providing sets of uniquely marked segments of data content according to claim 73, further comprising taking at least one fraction of said content, such that said fraction contains at least one of said content segments thereby to ensure that at least one of said content segments is taken from said fragment.

76. A method for providing sets of uniquely marked segments of data content according to claim 73, wherein each of said marked segments represents a predefined character.

77. A method for providing uniquely marked copies of data content according to claim 73, wherein said content comprises one of the following: audio content, video content, multimedia content, or data.

78. A method for providing uniquely marked copies of data content by inserting one of a selection of segments into a set of predefined locations within said data content, comprising:
providing, for each predefined location, a set of differently marked copies of a respective segment for said location;
selecting a marked copy from the set of marked segments of said respective location; and,
inserting said selected marked segment into said respective location in said data content.

79. A method for providing uniquely marked copies of data content according to claim 78, comprising the further step of removing from at least one of said locations a segment of said data content.

80. A method for providing uniquely marked copies of data content according to claim 78, such that each of said content segments is salient to said content, such that removal of said segment degrades said content.

81. A method for providing uniquely marked copies of data content according to claim 78, wherein marking said content is performed during distribution of said content.

82. A method for providing uniquely marked copies of data content according to claim 78, further comprising taking at least one fraction of said content, such that said fraction contains at least one of said content segments thereby to ensure that at least one of said content segments is taken from said fragment.

83. A method for providing uniquely marked copies of data content according to claim 78, wherein said marked copies of data content are not degraded relative to said content.

84. A method for providing uniquely marked copies of data content according to claim 78, wherein each of said marked segments represents a predefined character.

85. A method for providing uniquely marked copies of data content according to claim 84, wherein a marked copy of data content contains a message embedded therein.

86. A method for providing uniquely marked copies of data content according to claim 85, further comprising performing error correction encoding on said message.

87. A method for providing uniquely marked copies of data content according to claim 85, further comprising encrypting said message.

88. A method for providing uniquely marked copies of data content according to claim 78, wherein said content comprises one of the following: audio content, video content, multimedia content, or data.

89. A method for providing uniquely marked copies of data content according to claim 78, wherein a segment comprises a video frame, and wherein said data content is marked with a message comprising a sequence of marks by performing the steps of:
encoding said message into an encoded message using an error-correction code;
transforming the encoded message into a message matrix;
generating a pseudo-noise sequence and transforming said sequence into a pseudo-noise matrix;
combining the pseudo-noise matrix and the message matrix into a control matrix using the tensor product of the two matrices;
obtaining the video frame in a YUV format;
dividing the Y component into blocks;
extracting from each block the value of a component for manipulation during the embedding process;
manipulating the value of said components in accordance with the numbers in the control matrix to form a steganogram template;
combining said template with the original frame;
storing said frame and a sequence previously watermarked frames in a file; and
encoding said sequence of frame into a digital video format.

90. A method for watermarking data content by inserting one of a selection of previously removed segments into a set of predefined locations within said data content, comprising:
obtaining, for each predefined location, a set of differently marked copies of a respective segment for said location;
selecting a marked copy from the set of marked segments for each respective location; and,
inserting said selected marked segment into said respective location in said data content.

91. A method for providing uniquely marked copies of data content according to claim 90, wherein said marked copies of data content are not degraded relative to said content.

92. A method for providing uniquely marked copies of data content according to claim 90, wherein each of said marked segments represents a predefined character.

93. A method for providing uniquely marked copies of data content according to claim 91, wherein a marked copy of data content contains a message embedded therein.
